(19) United States
(12) Patent Application Publication
(10) Pub. No.: US 2026/0081698 A1
(43) Pub. Date: Mar. 19, 2026

(54) OPTICAL TRANSMITTER, DELAY CONTROL CIRCUIT AND METHOD

(71) Applicant: Fujitsu Limited, Kawasaki-shi (JP)

(72) Inventor: Yukito TSUNODA, Komae (JP)

(73) Assignee: Fujitsu Limited, Kawasaki-shi (JP)

(21) Appl. No.: 19/342,063

(22) Filed: Sep. 26, 2025

Related U.S. Application Data
(63) Continuation of application No. PCT/JP2024/008113, filed on Mar. 4, 2024.

(30) Foreign Application Priority Data
Mar. 31, 2023 (JP) 2023-056863

(51) Int. Cl. H04B 10/516; G02F 1/225; H04B 10/50

(52) U.S. Cl. CPC H04B 10/516; G02F 1/225; H04B 10/505

(57) ABSTRACT

An optical transmitter includes an optical modulator including three or more electrode segments that are along a waveguide constituting a Mach-Zehnder interferometer, and a delay control circuit configured to control input timings of a same signal to be input to the three or more electrode segments, during operation of the optical modulator. The three or more electrode segments to which the same signal is input have different modulation amounts with respect to light passing through the optical modulator. The delay control circuit is configured to control a first signal input timing of a target electrode segment to be controlled, among the three or more electrode segments, based on a second input timing of an electrode segment having the largest modulation amount, among other electrode segments.

### CROSS-REFERENCE TO RELATED APPLICATIONS

This application is a continuation application of International Application No. PCT/JP2024/008113, filed on Mar. 4, 2024, and designated the U.S., which is based upon and claims priority to Japanese Patent Application No. 2023-056863, filed on Mar. 31, 2023, the entire contents of which are incorporated herein by reference.

### FIELD

The embodiments discussed herein are related to optical transmitters, delay control circuits and methods.

### BACKGROUND

A configuration in which a plurality of signal electrodes are provided along one or both of two waveguides constituting a Mach-Zehnder (MZ) interferometer of an optical modulator and each electrode is independently driven is being adopted, as proposed in Japanese Laid-Open Patent Application Publication No. 2022-24347 and International Publication Pamphlet No. 2012/063413, for example. An optical modulator having such a configuration may be called a “segment modulator.” By dividing a long signal electrode into a plurality of electrodes and applying a drive voltage to each of the divided electrodes individually, the capacitance of a device is reduced, and high-frequency operation is enabled. In the segment modulator, delay control is performed to align a timing at which light passes through each electrode with a timing at which a data signal is input to the electrode.

Delay control in conventional segment modulators mainly addresses delays caused by variations in wiring lengths of electrical signals (several picoseconds to several tens of picoseconds) and delays caused by optical signal propagation delay (about 50 picoseconds). Delay adjustment is typically performed at the time of factory shipment. As baud rates increase in response to the rapid growth in communication traffic in recent years, delay variations occurring on an electronic circuit side due to variations and fluctuations in temperature, humidity, and the like in the environment where optical modulators are used cannot be ignored. When the delay amount fluctuates during the operation of the optical modulators, waveforms become distorted and communication quality deteriorates.

### SUMMARY

Accordingly, it is an object in one aspect of the embodiments to provide delay control technique for automatically controlling input timing deviation of a drive signal during operation of an optical modulator.

According to one aspect of the embodiments, an optical transmitter includes an optical modulator including three or more electrode segments that are along a waveguide constituting a Mach-Zehnder interferometer; and a delay control circuit configured to control input timings of a same signal to be input to the three or more electrode segments, during operation of the optical modulator. The three or more electrode segments to which the same signal is input have different modulation amounts with respect to light passing through the optical modulator. The delay control circuit is configured to control a first signal input timing of a target electrode segment to be controlled, among the three or more electrode segments, based on a second input timing of an electrode segment having the largest modulation amount, among other electrode segments.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a basic concept of delay control according to an embodiment.

FIG. 2 is a diagram illustrating an example of adjusting deviation of signal input timing to an electrode segment.

FIGS. 3A and 3B are diagrams illustrating an example of adjusting deviation of signal input timing to an electrode segment.

FIG. 4 is a diagram illustrating a configuration example of a digital coherent optical transmitter to which the delay control according to the embodiment is applied.

FIGS. 5A to 5C are diagrams illustrating delay control in a comparative configuration.

FIG. 6 is a diagram illustrating a configuration example of a plurality of electrode segments to which the same signal is input.

FIG. 7 is a diagram illustrating case 1 of delay adjustment.

FIG. 8 is a diagram illustrating case 2 of delay adjustment.

FIG. 9 is a diagram illustrating case 3 of delay adjustment.

FIG. 10 is a diagram illustrating the basic concept of the delay control in a modification.

FIG. 11 is a diagram illustrating a configuration example of an optical DAC transmitter for digital coherence to which the delay control of FIG. 10 is applied.

FIG. 12 is a flowchart of a delay control method.

### DESCRIPTION OF EMBODIMENTS

Embodiments of the present invention will be described with reference to the accompanying drawings.

Hereinafter, specific configurations and techniques of delay control according to embodiments will be described with reference to the drawings. The embodiments illustrated below are examples for embodying the technical concept of the present disclosure and are not intended to limit the contents of the disclosure. The sizes and positional relationship of components illustrated in the drawings may be exaggerated to facilitate the understanding of the invention. The same names or symbols may be given to the same components or functions to omit redundant description.

In the embodiments, during actual operation of a segmented optical modulator in which a signal electrode of an optical modulator is divided into a plurality of electrode segments, delay deviation, that is, timing deviation of signal input to the electrode segments, is adjusted and controlled. At the time of factory shipment or during startup of the optical modulator in the field, a delay amount between electrode segments can be relatively adjusted using a random training sequence or the like before starting communication. While relatively adjusting the delay deviation between a target electrode segment to be controlled and a reference electrode segment, signal inputs to other electrode segments are turned off. A delay control circuit can recognize that a monitoring result of output light from the optical modulator indicates which electrode segments have relative timing deviation between these segments. On the other hand, input of a data signal to the optical modulator cannot be stopped during actual operation. While operating the optical modulator, a creative approach is needed to adjust relative delay deviation between a plurality of electrode segments, that is, timing deviation of signal inputs.

During the actual operation of the optical modulator, in order to control the signal input timing among three or more electrode segments to which the same signal is input, modulation amounts are varied among three or more electrode segments to which the same signal is input. The modulation amounts can be varied by making sizes of the electrode segments different, making the modulation strengths different, or the like. When the lengths of the electrode segments are varied for the same signal input, an interaction length between light and electricity changes, resulting in changes in the modulation amount. The modulation strength or modulation degree is expressed by signal intensity relative to the intensity of a carrier wave, and the strength or degree can be changed, for example, by varying the amplitude of the same signal to be input to electrode segments.

In a state where the same signal is input to three or more electrode segments, the influence in an electrode segment with the largest modulation amount becomes most dominant. When the delay amount of any one electrode segment among three or more electrode segments to which the same signal is input is adjusted, delay control is performed in accordance with a signal input timing of the electrode segment that has the largest modulation influence among the remaining electrode segments.

### Basic Concept of Delay Control of Embodiment

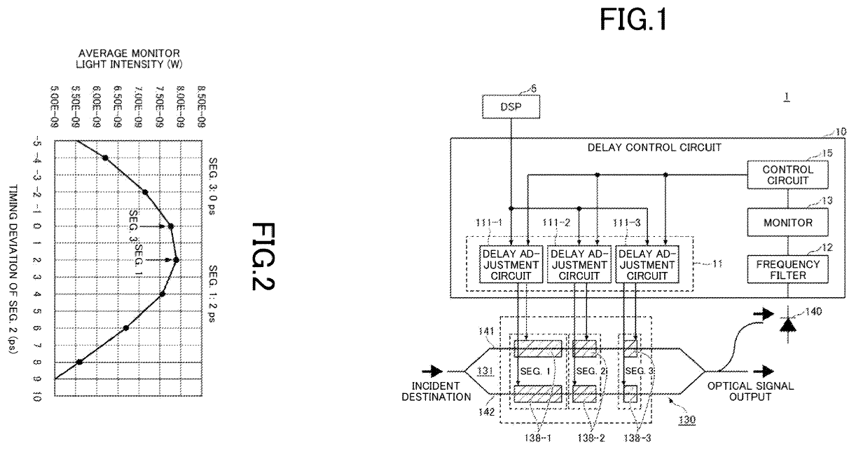

FIG. 1 is a diagram illustrating a basic concept of the delay control according to the embodiment. In order to clearly illustrate the basic concept of the delay control, a part of a main portion of an optical transmitter 1 is illustrated in a simplified manner. The optical transmitter 1 includes an optical modulator 130, a digital signal processor (DSP) 5 that generates and outputs a data signal to be input to the optical modulator 130, and a delay control circuit 10 that controls a delay amount of the data signal to be input to the optical modulator 130. Here, the description will focus on one of data signals output from the DSP 5.

The optical modulator 130 is a Mach-Zehnder (MZ) modulator in which an MZ interferometer is formed by two waveguides 141 and 142 connected in parallel. A plurality of divided signal electrodes are provided along at least one of the waveguide 141 or the waveguide 142. Each of the divided signal electrodes is referred to as an “electrode segment” for convenience. Electrode segments 138-1, 138-2, and 138-3 (which hereinafter may be collectively referred to as “electrode segments 138”) are each provided along a corresponding waveguide among the waveguides 141 and 142, and the same data signal is input to these electrode segments 138-1, 138-2, and 138-3.

The electrode segments 138-1, 138-2, and 138-3 are referred to as “seg. 1,” “seg. 2,” and “seg. 3,” respectively. The sizes of the electrode segments 138 increase in the order of seg. 1, seg. 2, and seg. 3. When light passing through the waveguides 141 and 142 is modulated by the input data signal, the modulation effect of the longest seg. 1 is dominant. If an input timing of the signal that acts on the light passing directly under each electrode segment is adjusted in accordance with a timing of the signal input to the seg. 1, the intensity of an optical signal output from the optical modulator 130 increases.

A portion of the optical signal that is modulated by the optical modulator 130 is branched and detected by a monitor PD (Photo Diode) 140. The monitor PD 140 is an example of a photodetector. The monitor PD 140 outputs a photocurrent proportional to the intensity of the optical signal output from the optical modulator 130. An electrical signal representing the intensity of the output light from the optical modulator 130 is input to a delay control circuit 10.

The delay control circuit 10 includes a delay circuit 11, a frequency filter 12, a monitor 13, and a control circuit 15. The frequency filter 12 is a bandpass filter that extracts a specific frequency component from the input electrical signal. The monitor 13 monitors a power spectrum of the extracted frequency component. By extracting the specific frequency component from the electric signal, the timing deviation of the signal input can be adjusted with desired accuracy. If there is a minute deviation in the timing of inputting the signal to the electrode segment 138, the intensity of the output light from the optical modulator 130 from a high-frequency region decreases according to an amount of the timing deviation. In the case of the delay control during the actual operation, it is preferable to extract high-frequency components by the frequency filter 12 and monitor the attenuation, because a minute timing deviation due to temperature variations and humidity variations in the usage environment is controlled. By setting a center frequency of the frequency filter 12 high, a range of controllable timing deviations, that is, a delay deviation, becomes narrow, but a minute delay deviation can be detected with high accuracy by the monitor 13.

The control circuit 15 controls adjustment amounts for the delay adjustment circuits 111-1, 111-2, and 111-3 of the delay circuit 11 based on a monitoring result from the monitor 13. For example, when seg. 1 is a control target, a delay amount of a corresponding delay adjustment circuit 111-1 is controlled, and the delay amount is set to maximize the monitoring result from the monitor 13. The delay amount of seg. 1, that is, a signal input timing, is controlled according to a signal input timing of seg. 2 or seg. 3, whichever is more significantly affected by modulation. The electrode segments to be controlled are sequentially selected, and delay control is performed in the same manner according to the signal input timing of the electrode segment that has the largest modulation influence, among the other electrode segments. In this arrangement, the timing deviation can be minimized among three or more electrode segments 138-1, 138-2, and 138-3, to which the same signal is input, without stopping signal input.

FIG. 2 illustrates an example of adjusting the timing deviation of seg. 2. The signal input timing (delay amount) of seg. 2 has a deviation of 2.0 picoseconds relative to seg. 1, and is aligned with seg. 3 (0 picoseconds). The control circuit 15 aims to control the input timing of seg. 2 to maximize the power monitored by the monitor 13. In a state where the same signal is input to three electrode segments having the same size, it cannot be determined how the signal input timing to seg. 2 should be aligned with respect to seg. 1 and seg. 3. On the other hand, in the embodiment, the delay amount of seg. 2 is controlled in accordance with the signal input timing of seg. 1, which has a large modulation amount, so that a timing deviation between seg. 2 and seg. 1 is minimized.

By adjusting the signal input timing of seg. 2 to minimize the timing deviation with the seg. 1, which has the largest modulation amount, average light intensity detected by the monitor PD 140 approaches maximum as illustrated in FIG. 2. When subsequently adjusting the delay amount of seg. 3, a timing deviation among three electrode segments 138 is minimized by adjusting the delay amount according to the signal input timing of the seg. 1 with the largest modulation influence.

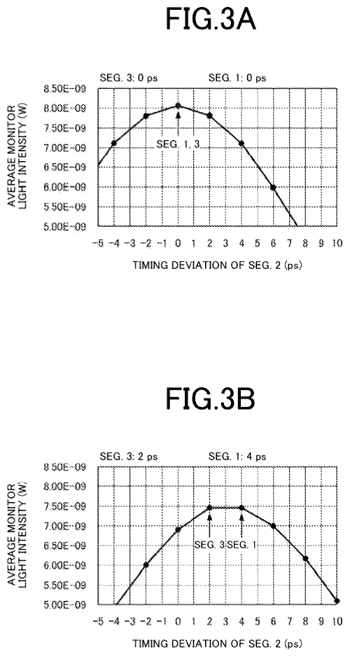

FIGS. 3A and 3B illustrate another example of adjusting the signal input timing deviation of seg. 2. Another adjustment example of the signal input timing deviation of seg. 2 is illustrated. FIG. 3A illustrates a state in which the signal input timing of seg. 2 has no deviation relative to either seg. 1 or seg. 3. In this case, intensity of output light from the optical modulator 130 decreases regardless of which direction the delay amount of the delay adjustment circuit 111-2 (see FIG. 1) is changed. The control circuit 15 maintains a current modulation amount of seg. 2 based on the signal input timing of seg. 1, which has the largest modulation amount.

In FIG. 3B, the signal input timing to seg. 2 has a deviation of 4 picoseconds relative to seg. 1, and has a deviation of 2 picoseconds relative to seg. 3. The control circuit 15 controls the delay amount of the delay adjustment circuit 111-2 so as to minimize the signal input timing deviation with seg. 1, which has the largest modulation amount.

The delay control illustrated in FIG. 1 can be uniformly applied to a case where there is no deviation between the signal input timings of seg. 1 and seg. 3 as illustrated in FIG. 3A, or a case where there is no change in optical output power regardless of which signal input timing, seg. 1 or seg. 3, is matched. In either case, the signal input timing of the electrode segment to be controlled is controlled in accordance with the signal input timing of the seg. 1 with the largest modulation amount.

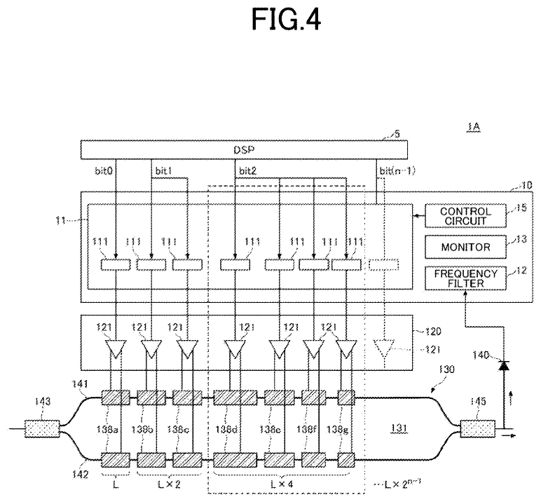

FIG. 4 illustrates a configuration example of an optical transmitter 1A for digital coherence to which the delay control according to the embodiment is applied. The optical modulator 130 has an MZ interferometer composed of waveguides 141 and 142 that are connected in parallel between a demultiplexer 143 and a multiplexer 145. A plurality of divided electrode segments 138a to 138g (which hereinafter may be collectively referred to as “electrode segments 138” as appropriate) are provided along each of the waveguides 141 and 142. Each of the electrode segments 138 receives a signal for each bit that is delay-adjusted by a corresponding delay adjustment circuit 111. The signal that is input to each of the electrode segments 138 is an NRZ (Non-Return-to-Zero) signal representing a digital bit.

When an n-bit signal is input to the optical modulator 130, the number of electrode segments 138 to which a bit 0 signal is input is 2⁰, which is one. The number of electrode segments 138 to which a bit 1 signal is input is 2¹, which is two. The number of electrode segments 138 to which a bit 2 signal is input is 2², which is four. The number of electrode segments 138 to which a bit (n-1) signal, which is the most significant bit (MSB), is input is 2⁽ⁿ⁻¹⁾. The n-bit signal is a digital electrical signal until input to one or more electrode segments 138, and an analog optical signal is generated by the optical modulator 130. In this case, the optical transmitter 1A may be called an “optical digital-analog converter (DAC)”transmitter.

The same bit 1 signal is input to the electrode segments 138b and 138c, and delay adjustment is performed between the two electrode segments 138b and 138c. Since delay adjustment for bit 1 signals always occurs between the two electrode segments 138, the electrode segments 138b and 138c have the same size. The signal electrode with the length required for bit 1 data modulation is divided into two electrode segments 138b and 138c of approximately the same length, and thus capacitance is reduced. The bit 1 signal is amplified by a corresponding amplifier 121, and is input to the electrode segments 138b and 138c. The amplifier 121 is an inverter driver into which current flows only at the time of data transition, and as a result, power consumption is reduced.

The electrode segments 138d, 138e, 138f, and 138g to which the same bit 2 signal is input are formed to have different sizes and different modulation amounts. When the modulation amounts of the electrode segments 138d, 138e, 138f, and 138g are totaled, a modulation amount required for bit 2 data modulation is obtained. In this arrangement, timings of signal inputs to the electrode segments 138d, 138e, 138f, and 138g are controlled in accordance with a signal input timing of an electrode segment with a large modulation influence.

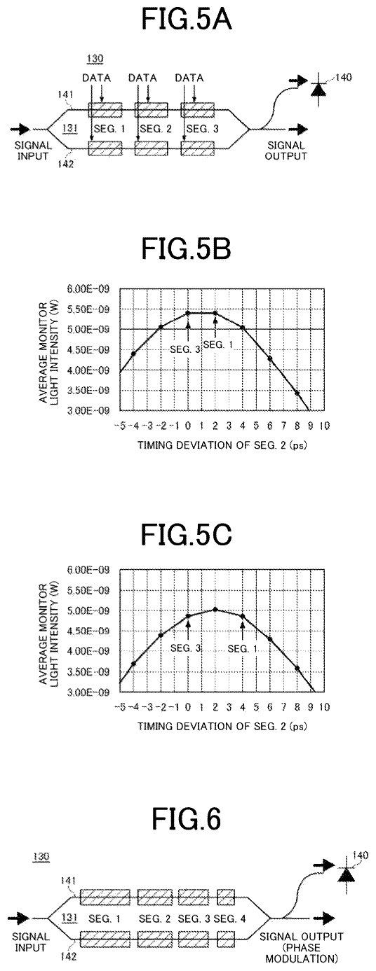

FIGS. 5A, 5B, and 5C illustrate delay control in a comparative configuration. FIG. 5A illustrates a configuration example in which the same data signal is input to three electrode segments seg. 1, seg. 2, and seg. 3 with the same modulation amount. When the delay control is performed based on the monitoring result of the output light from the optical modulator 13, the delay control circuit 10 cannot determine whether power attenuation reflected in the monitoring result is caused by the timing deviation between an electrode segment to be controlled and any other electrode segment.

In FIG. 5B, the signal input timing to seg. 2 has a deviation of 2 picoseconds relative to seg. 1, but has no deviation relative to seg. 3.

In order to maintain maximum monitor light intensity, the signal input timing of seg. 2 should be aligned with either the signal input timing of seg. 1 or the signal input timing of seg. 3.

However, the control circuit 15 cannot determine which signal input timing to align with.

In FIG. 5C, the signal input timing to seg. 2 has a deviation of 4 picoseconds relative to seg. 1, but has no timing deviation relative to seg. 3. A region where monitor light is maximized is situated somewhere between the signal input timing of seg. 1 and the signal input timing of seg. 3, but the control circuit 15 cannot determine which signal input timing to align with and how to perform the alignment.

On the other hand, in the configuration illustrated in FIGS. 1 and 4 in which the same signal is input to three or more electrode segments, modulation amounts of the three or more electrode segments are made different. By adjusting a signal input timing to the electrode segment to be controlled to align with a timing of a given electrode segment with the largest influence, that is, a given electrode segment with the largest modulation amount, among the remaining electrode segments, relative delay control can be implemented among three or more electrode segments to which the same signal is input.

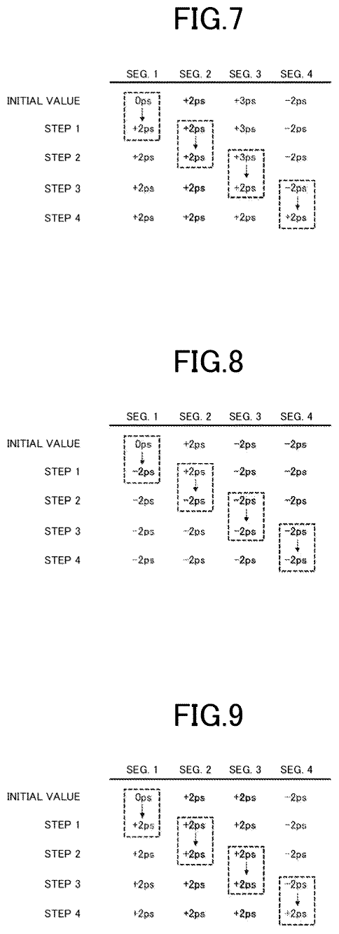

FIG. 6 illustrates a configuration example of four electrode segments to which the same signal is input. Along each of waveguides 141 and 142 comprised of the MZ interferometer 131 of the optical modulator 130, four signal electrodes with different lengths created by division are provided. The lengths of the divided signal electrodes increase in the order of seg. 1, seg. 2, seg. 3, and seg. 4. A total length of seg. 3 and seg. 4 is greater than the length of seg. 2 and less than the length of seg. 1 (seg. 1>seg. 3+seg. 4>seg. 2). Examples of delay adjustment in this model will be described with reference to FIGS. 7 to 9.

### Case 1 of Delay Adjustment

FIG. 7 illustrates case 1 of delay adjustment in the model of FIG. 6. Case 1 is a scenario in which all initial values of delay amounts for the same signal to be input to the four electrode segments differ. After starting the operation of the optical modulator 130, timings of signals input to the four electrode segments are sequentially adjusted. For example, first, seg. 1 is to be controlled. Although initial control of seg. 1 is not required, a segment with a larger modulation amount causes a large change in the output light of the optical modulator 130, and thus makes detection easier.

When controlling the signal input timing of seg. 1, the timing is aligned with a signal input timing of an electrode segment with the largest modulation amount among the other three electrode segments. In the model of FIG. 6, seg. 2 has the largest modulation amount among the remaining three electrode segments. In such a case, the signal input timing of seg. 1 is adjusted to be aligned with the signal input timing of seg. 2 (step 1). Next, seg. 2 is to be controlled. Among three electrode segments except seg. 2, seg. 1 has the largest modulation amount. In such a case, the timing of seg. 2 is aligned with the signal input timing of seg. 1. In this case, since the signal input timings of seg. 1 and seg. 2 are already aligned, the delay amount of seg. 2 is kept unchanged (step 2).

Next, seg. 3 is to be controlled. Among three electrode segments excluding seg. 3, seg. 1 has the largest modulation amount, and the signal input timing of seg. 3 is adjusted to be aligned with the signal input timing of seg. 1 (step 3). In the example of FIG. 7, control is performed in a direction of reducing the delay amount of seg. 3. Finally, seg. 4 is to be controlled. Since seg. 1 has the largest modulation amount among three electrode segments excluding seg. 4, the signal input timing of seg. 4 is adjusted to be aligned with the signal input timing of seg. 1. In this case, signal input timings of four electrode segments, that is, delay amounts, are adjusted, and output light power from the optical modulator 130 is maximized.

### Case 2 of Delay Adjustment

FIG. 8 illustrates case 2 of delay adjustment in the model of FIG. 6. Case 2 is a scenario in which initial values for delay amounts of seg. 3 and seg. 4 are the same. Seg. 1 is to be controlled. Among the other three electrode segments, the modulation amount of an electrode portion combining seg. 3 and seg. 4 becomes greater than the modulation amount of seg. 2. In this arrangement, the signal input timing of seg. 1 is adjusted to be aligned with the signal input timing of seg. 3 or seg. 4 (step 1). Next, seg. 2 is to be controlled. The signal input timing of seg. 2 is adjusted to be aligned with seg. 1 with the largest modulation amount (step 2).

Next, seg. 3 is to be controlled. The signal input timing of seg. 3 is aligned with the signal input timing of seg. 1. Since the signal input timings of seg. 1 and seg. 3 are already adjusted, the delay amount of seg. 3 is kept unchanged (step 3). Next, seg. 4 is to be controlled. The signal input timing of seg. 4 is aligned with the signal input timing of seg. 1. Since the signal input timings of seg. 1 and seg. 4 are already adjusted, the delay amount of seg. 4 is kept unchanged (step 4). In this case, signal input timings of four electrode segments are adjusted, and thus output light power from the optical modulator 130 is maximized.

### Case 3 of Delay Adjustment

FIG. 9 illustrates case 3 of delay adjustment in the model of FIG. 6. Case 3 is a scenario in which initial values of delay amounts of delay adjustment circuits for seg. 2 and seg. 3 are the same. A total length of seg. 2 and seg. 3 is greater than that of seg. 1. In other words, a modulation amount of an electrode portion combining seg. 2 and seg. 3 becomes the maximum.

When seg. 1 is to be controlled, modulation influence in an electrode portion combining seg. 2 and seg. 3 is maximized among the other three electrode segments. The signal input timing of seg. 1 is adjusted to be aligned with the signal input timing of seg. 2 or seg. 3 (step 1). Next, seg. 2 is set as the control target. Since the signal input timings of seg. 2 and seg. 1 are already adjusted, the delay amount of seg. 2 is kept unchanged (step 2).

Next, seg. 3 is to be controlled. The signal input timing of seg. 3 is adjusted to be aligned with the signal input timing of seg. 1. Since the signal input timings of seg. 1 and seg. 3 are already adjusted, the delay amount of seg. 3 is kept unchanged (step 3). Next, seg. 4 is to be controlled. The signal input timing of seg. 4 is adjusted to be aligned with the signal input timing of seg. 1 (step 4). In this case, signal input timings of four electrode segments are adjusted, and thus power of output light from the optical modulator 130 is maximized.

The delay control according to the embodiment is applied both when all signal input timings differ among three or more electrode segments and when signal input timings are matched between two or more electrode segments. Among four electrode segments to which the same signal is input, it is sufficient to align with a signal input timing to any one of an electrode portion that has the largest dominant modulation influence, and thus a direction (sign) and an absolute value of delay deviation do not matter. During actual operation of the optical modulator 130, minute variations in the delay amount can be controlled without interrupting a signal input. This delay control is particularly effective when the delay control at the timing of factory shipment has been performed but there is no readjustment of delay amounts during startup of an optical transmitter at an installation site.

### Modification

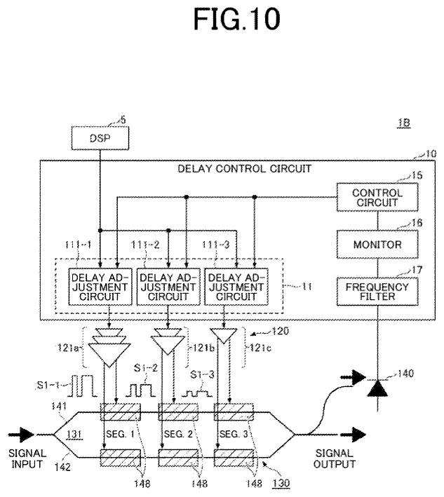

FIG. 10 is a schematic diagram illustrating a basic concept of the delay control in a modification. In the modification, in order to vary modulation amounts of three or more electrode segments, the amplitude or amplification factor of the same data signal to be input to the electrode segments is varied.

An optical transmitter 1B includes the optical modulator 130, the DSP 5 that generates and outputs a data signal to be input to the optical modulator 130, the delay control circuit 10 that controls a delay amount of a data signal to be input to the optical modulator 130, and an amplifier circuit 120 that amplifies the data signal to be input to the optical modulator 130. Here, the description will focus on one of a plurality of data signals output from the DSP 5. The amplifier circuit 120 includes amplifiers 121a, 121b, and 121c, and amplifies the same data signal with different amplification factors.

The optical modulator 130 is an MZ modulator in which an MZ interferometer is comprised of two waveguides 141 and 142 that are connected in parallel. The optical modulator 130 includes a plurality of divided signal electrodes along at least one of the waveguides 141 and 142. Each of the divided signal electrodes is referred to as an “electrode segment” for convenience. A plurality of electrode segments 148 divided into the same size are provided along each of the waveguides 141 and 142. The electrode segments 148 are referred to as “seg. 1,” “seg. 2,” and “seg. 3,” respectively.

The amplitude or amplification factor of the signal to be input to the electrode segment 148 increase in the order of seg. 1, seg. 2, and seg. 3. When light passing through the waveguides 141 and 142 is modulated by the input signal, seg. 1 has the largest modulation amount and the modulation influence of seg. 1 is most dominant. If a timing of the signal input that acts on the light passing directly under each electrode segment is adjusted to be aligned with the signal input timing of seg. 1 that has the largest modulation amount, the intensity of the optical signal output of the optical modulator 130 increases.

A configuration of the delay control circuit 10 provided between the DSP 5 and the optical modulator 130 is as described with reference to FIG. 1. The same signal that is delay-adjusted by the delay adjustment circuits 111-1, 111-2, and 111-3 of the delay circuit 11 is amplified with different amplification factors by the corresponding amplifiers 121a, 121b, and 121c. The signal that is delay-adjusted by the delay adjustment circuit 111-1 is amplified by the amplifier 121a and input to seg. 1 as a signal S1-1.

The signal that is delay-adjusted by the delay adjustment circuit 111-2 is amplified by the amplifier 121b with an amplification factor lower than that of the amplifier 121a and input to seg. 2 as a signal S1-2. The signal that is delay-adjusted by the delay adjustment circuit 111-3 is amplified by the amplifier 121c with an amplification factor lower than that of the amplifier 121b and input to seg. 3 as a signal S1-3.

A portion of the optical signal modulated by the optical modulator 130 is detected by the monitor PD 140, and an electrical signal representing a monitoring result is input to the delay control circuit 10. The delay control circuit 10 extracts a specific frequency component from the input electrical signal and monitors a power spectrum of the extracted frequency component. The control circuit 15 controls adjustment amounts of the delay adjustment circuits 111-1, 111-2, and 111-3 such that the monitored power approaches maximum. The delay amount of each delay adjustment circuit 111 is adjusted to be aligned with the signal input timing of the other electrode segment that has the most dominant modulation influence.

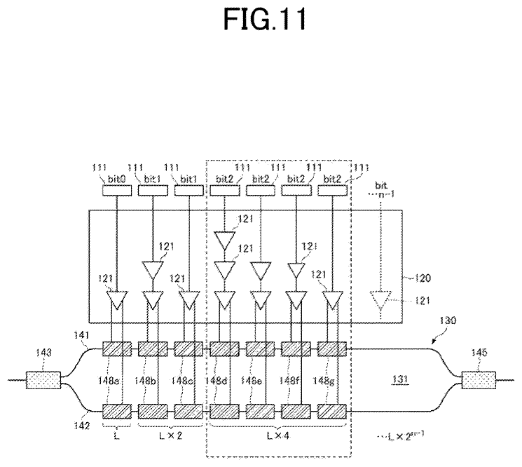

FIG. 11 illustrates a configuration example of an optical DAC transmitter for digital coherence to which the delay control of FIG. 10 is applied. As in FIG. 4, a case where an n-bit signal is input to the optical modulator 130 is considered. A plurality of divided electrode segments 148a to 148g are provided along at least one of waveguides 141 and 142 comprised of an MZ interferometer of the optical modulator 130. The electrode segments 148a to 148g have the same size or length.

As blocks including three or more electrode segments to which the same data signal is input, blocks of electrode segments 148d to 148g to which a bit-2 signal is input are focused. The electrode segments 148d, 148e, 148f, and 148g are formed to have the same size, but the amplitude of the same data signal to be input differs. As a result, the modulation amounts of the electrode segments 148d, 148e, 148f, and 148g differ. When the modulation amounts of the electrode segments 148d, 148e, 148f, and 148g are totaled, a modulation amount necessary for bit 2 data modulation is obtained. In this arrangement, a timing of the signal that is input to the electrode segments 148d, 148e, 148f, and 148g is controlled in accordance with a timing of the electrode segment that has the largest modulation amount. Specific examples of the delay control have been described with reference to FIGS. 7 to 9. Even in this arrangement, a minute delay deviation can be adjusted without interrupting a signal input during actual operation of the optical modulator 130.

### Delay Control Method

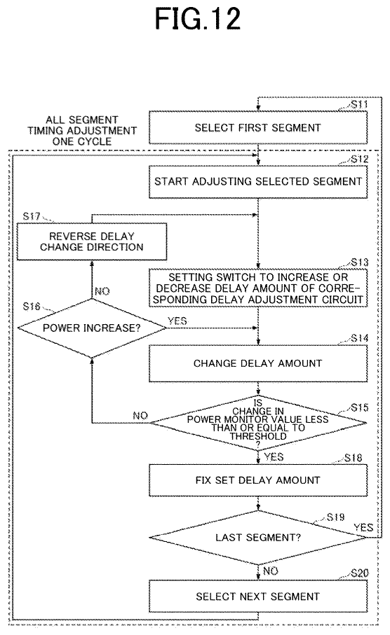

FIG. 12 is a flowchart of a delay control method according to the embodiment. This control flow is executed by the delay control circuit 10 during operation of the optical modulator 130, that is, during operation of the optical transmitter 1. A first segment is selected from among three or more electrode segments to which the same signal is input (S11), and delay adjustment of this electrode segment is started (S12). Any electrode segment may be selected, but if an electrode segment having a large modulation amount is selected, a change in output light of the optical modulator 130 is easily detected. The setting of a delay amount of the delay adjustment circuit 111 for an electrode segment to be controlled is switched (S13), and the delay amount is changed in an increasing or decreasing direction (S14). The delay amount may be changed toward the minimum or maximum from a current delay amount within an adjustable range, or may be changed in either direction from the center of the adjustable range. The delay amount may be swept from minimum to maximum, or from the maximum to the minimum.

A predetermined frequency component is extracted from the monitoring result of the output light from the optical modulator 130, and a corresponding power spectrum is monitored to determine whether a change amount of power monitoring due to a change in the delay amount is equal to or less than a threshold (S15). If the monitoring result changes only within a range equal to or less than the threshold despite the change in the delay amount (YES in S15), current optical output intensity of the optical modulator 130 is at maximum or a local maximum, and as a result, the signal input timing to the electrode segment to be controlled is appropriate. In this case, the delay amount of a corresponding delay adjustment circuit 111 is fixed to a current delay amount (S18).

If the monitoring result changes beyond the threshold (NO in S15), it is determined whether the monitored power has changed in an increasing direction (S16). If the monitored power has changed in an increasing direction (YES in S16), the delay control direction is correct, and the delay amount is further changed in the same control direction (S14). Steps S14 to S16 are repeated until a variation in the monitored power becomes equal to or less than the threshold (YES in S15).

If a change direction in the monitored power is not an increasing direction (NO in S16), a control direction is incorrect. In this case, the setting of the delay adjustment circuit 111 is switched (S13) such that the change direction in the delay amount becomes an opposite direction (S17), and the delay amount is changed (S14). Steps S13 to S17 are repeated until the change of the delay amount converges to a threshold or less (YES in S15). When the variation in the monitored power converges to a threshold or less, the delay amount of the corresponding delay adjustment circuit 111 is fixed to the current delay amount (S18). At this stage, the signal input timing of the electrode segment to be controlled is relatively adjusted with respect to the electrode segment with the largest modulation amount among the other electrode segments to which the same signal is input.

Next, it is determined whether a current control target is the last segment, that is, whether there is another electrode segment to be controlled. If there is another electrode segment to be controlled (NO in S19), the next electrode segment is selected (S20). Steps S12 to S20 are repeated. If the current control target is the last electrode segment (YES in S19), one-cycle timing adjustment is completed among all electrode elements of the blocks to be controlled. Then, the process returns to step S11 to start the next control cycle. The control operation illustrated in FIG. 12 is repeated during the operation of the optical transmitter 1.

By this delay control method, during the actual operation of the optical modulator 130, timing adjustment of signal input is performed among three or more electrode segments to which the same signal is input without interrupting a signal input. As in case 3 of FIG. 9, signal input timings of seg. 2 and seg. 3 coincide by chance. It is also possible to handle a case where a total modulation amount of seg. 2 and seg. 3 is larger than the modulation amount of seg. 1.

Although the configuration and method of the delay control according to the embodiments have been described based on a specific configuration example, the present disclosure is not limited to the configuration and method described above. The configuration and method according to the embodiments can also be applied to the delay control in a block of each bit higher than bit 2 when a data signal of 4 bits or more is input, for example. In the embodiments, the delay amount of each delay adjustment circuit is adjusted so as to maximize the output light power from the optical modulator 130. However, in a case of phase modulation, the delay may be adjusted so as to minimize the monitored power. When an optical modulator having a plurality of divided electrode segments is considered to be equalized with a finite impulse response (FIR) filter, a predetermined frequency component is removed by adding a timing deviation (delay) of a signal input to an electrode segment (digital filter). The removed frequency component may be detected from the power spectrum measured by the monitor 13, and the delay may be adjusted in a direction to compensate for this frequency component. In this case as well, the signal input timing is relatively adjusted between an electrode segment to be controlled and an electrode segment having the largest modulation influence among the other electrode segments.

Many other variations and modifications will be apparent to those skilled in the art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical transmitter comprising:
an optical modulator including three or more electrode segments that are along a waveguide constituting a Mach-Zehnder interferometer; and
a delay control circuit configured to control input timings of a same signal to be input to the three or more electrode segments, during operation of the optical modulator,
wherein the three or more electrode segments to which the same signal is input have different modulation amounts with respect to light passing through the optical modulator, and
wherein the delay control circuit is configured to control a first signal input timing of a target electrode segment to be controlled among the three or more electrode segments, based on a second input timing of an electrode segment with a largest modulation amount among other electrode segments.

2. The optical transmitter according to claim 1, wherein the three or more electrode segments have different sizes and lengths, and
wherein the same signal is to be input to the three or more electrode segments.

3. The optical transmitter according to claim 1, wherein the same signal is to be input to the three or more electrode segments at different amplitudes.

4. The optical transmitter according to claim 3, further comprising:
an amplifier circuit configured to amplify the same signal with different amplification factors.

5. The optical transmitter according to claim 1, wherein the delay control circuit is configured to perform delay adjustment in order from an electrode segment with a largest modulation amount among the three or more electrode segments.

6. The optical transmitter according to claim 1, wherein the delay control circuit is configured to adjust the input timings of the same signal to be input to the three or more electrode segments such that output optical power of the optical modulator approaches maximum.

7. The optical transmitter according to claim 6, wherein the delay control circuit includes a frequency filter configured to extract a predetermined frequency component from an electrical signal representing a detection result of output light from the optical modulator, and
wherein the delay control circuit is configured to adjust the input timings of the same signal to be input to the three or more electrode segments such that output optical power of the frequency component extracted by the frequency filter approaches maximum.

8. A delay control circuit comprising:
a delay circuit configured to adjust delays of a same signal to be input to three or more electrode segments that have different modulation amounts, the three or more electrode segments being provided along a waveguide in a Mach-Zehnder interferometer of an optical modulator;
a monitor configured to monitor output optical power of the optical modulator; and
a control circuit configured to control input timings of the same signal to be input to the three or more electrode segments having the different modulation amounts, based on a monitoring result by the monitor.

9. The delay control circuit according to claim 8, wherein the control circuit is configured to adjust the input timings of the same signal to be input to the three or more electrode segments such that the power monitored by the monitor is maximized.

10. The delay control circuit according to claim 9, further comprising:
a frequency filter configured to extract a predetermined frequency component from an electrical signal representing a detection result of output light from the optical modulator,
wherein the monitor is configured to monitor power having the extracted predetermined frequency component, and
wherein the control circuit is configured to adjust the input timings of the same signal to be input to the three or more electrode segments such that the power having the predetermined frequency component approaches maximum.

11. A delay control method comprising:
setting different modulation amounts for three or more electrode segments that are along a waveguide constituting a Mach-Zehnder interferometer of an optical modulator;
inputting a same signal to the three or more electrode segments for which the different modulation amounts are set; and
controlling a first signal input timing of a target electrode segment to be controlled, among the three or more electrode segments, based on a second input timing of an electrode segment having the largest modulation amount among other electrode segments.

12. The delay control method according to claim 11, wherein the inputting includes inputting the same signal to the three or more electrode segments that have different sizes and lengths.

13. The delay control method according to claim 11, wherein the inputting includes inputting the same signal to the three or more electrode segments at different amplitudes.

14. The delay control method according to claim 11, wherein the controlling includes performing delay adjustment in order from an electrode segment with a largest modulation amount.

15. The delay control method according to claim 11, wherein the controlling includes adjusting the input timings of the same signal to be input to the three or more electrode segments such that output optical power of the optical modulator approaches maximum.
